(19) United States
(12) Patent Application Publication
(10) Pub. No.: US 2018/0304723 A1
(43) Pub. Date: Oct. 25, 2018

(54) AIR-CONDITIONING CONTROL APPARATUS

(71) Applicant: Panasonic Intellectual Property Management Co., Ltd., Osaka (JP)

(72) Inventors: YOICHI NISHIJIMA, Osaka (JP); KATSUMI KAKIMOTO, Osaka (JP); HIROSHI YAMANAKA, Fukui (JP); SHO SHIMADA, Fukui (JP); ISAO HATTORI, Fukui (JP); TAKANORI SUGIYAMA, Fukui (JP); TAKESHI YOSHIDA, Fukui (JP)

(21) Appl. No.: 15/571,833

(22) PCT Filed: Jun. 24, 2016
(86) PCT No.: PCT/JP2016/003055

§ 371 Date: Nov. 5, 2017

Related U.S. Application Data
(60) Provisional application No. 62/199,807, filed on Jul. 31, 2015.
(60) Provisional application No. 62/187,732, filed on Jul. 1, 2015.

(51) Int. Cl. B60H 1/00; G01J 5/08

(52) U.S. Cl. CPC B60H 1/00742; B60H 1/00764; G01J 2005/0077; G01J 5/0806; G01J 5/089

(57) ABSTRACT

An air-conditioning control apparatus includes a detector that obtains a thermal image of an occupant, a processing unit that estimates the thermal sensation of the occupant from a temperature distribution obtained by the detector, and a control unit that controls an air conditioner according to the estimation result of the thermal sensation. Upon detecting the occupant, the detector captures a thermal image of an area around the occupant.

### TECHNICAL FIELD

The present disclosure relates to an air-conditioning control apparatus for detecting a temperature of an object without contacting and controlling an air conditioner.

### BACKGROUND ART

An air-conditioning control suited to the thermal sensation of an occupant in consideration of a temperature at the occupant's feet is known. The air-conditioning control is performed by obtaining the temperature distribution of the upper half of the occupant's body and the temperature distribution of the lower half of the occupant's body (PTL 1).

A method for obtaining a temperature distribution with an infrared sensor performing scanning is known. A method of scanning with an infrared sensor at a scanning speed which is changed is known (PTL 2).

A method for enlarging the viewing angle of an infrared sensor with a mirror arranged ahead of the infrared sensor and performing scanning is known (PTLs 3 to 5).

### CITATION LIST

### Patent Literature

PTL 1: Japanese Patent Laid-Open Publication No. 2005-104221

PTL 2: Japanese Patent Laid-Open Publication No. 62-204670

PTL 3: Japanese Utility Model Laid-Open Publication No. 59-92830

PTL 4: Japanese Patent Laid-Open Publication No. 04-32378

PTL 5: Japanese Patent Laid-Open Publication No. 07-87393

### SUMMARY

An air-conditioning control apparatus is configured to detect an occupant, obtain a temperature distribution, estimate a thermal sensation of the occupant based on the temperature distribution, and control an air conditioner in accordance with the thermal sensation. According to the result of the detection of the occupant, a method for obtaining a temperature distribution is changed.

This air-conditioning control apparatus reduces a time for detecting an occupant, and enhances responsiveness.

### BRIEF DESCRIPTION OF THE DRAWINGS

FIG. 1 illustrates a vehicle having an air-conditioning control apparatus according to Exemplary Embodiment 1 installed thereto.

FIG. 2 is a block diagram of the air-conditioning control apparatus according to Embodiment 1.

FIG. 3 illustrates scanning performed by a detector of the air-conditioning control apparatus according to Embodiment 1.

FIG. 4 illustrates pixel units of the air-conditioning control apparatus according to Embodiment 1.

FIG. 5 illustrates a method of performing scanning by the detector of the air-conditioning control apparatus according to Embodiment 1 in a low-speed swing mode.

FIG. 6 illustrates the method of performing scanning by the detector of the air-conditioning control apparatus according to Embodiment 1 in a high-speed swing mode.

FIG. 7 illustrates the method of performing scanning by the detector of the air-conditioning control apparatus according to Embodiment 1 in the low-speed swing mode.

FIG. 8 illustrates a method of performing scanning by a detector of an air-conditioning control apparatus according to Exemplary Embodiment 2 in a low-speed swing mode.

FIG. 9 illustrates the method of performing scanning by the detector of the air-conditioning control apparatus according to Embodiment 2 in an occupant detection mode.

FIG. 10 illustrates the method of performing scanning by the detector of the air-conditioning control apparatus according to Embodiment 2 in the low-speed swing mode.

FIG. 11 illustrates a method of performing scanning by a detector of an air-conditioning control apparatus according to Exemplary Embodiment 3 in a low-speed swing mode.

FIG. 12 illustrates the method of performing scanning by the detector of the air-conditioning control apparatus according to Embodiment 3 in a high-speed swing mode.

FIG. 13 illustrates the method of performing scanning by the detector of the air-conditioning control apparatus according to Embodiment 3 in the low-speed swing mode.

FIG. 14 illustrates a method of performing scanning by a detector of an air-conditioning control apparatus according to Exemplary Embodiment 4 in a low-speed swing mode.

FIG. 15 illustrates the method of performing scanning by the detector of the air-conditioning control apparatus according to Embodiment 4 in a high-speed swing mode.

FIG. 16 illustrates the method of performing scanning by the detector of the air-conditioning control apparatus according to Embodiment 4 in the low-speed swing mode.

FIG. 17 is a schematic diagram of an air-conditioning control apparatus according to Exemplary Embodiment 5.

FIG. 18 is a block diagram of an air-conditioning control apparatus according to Exemplary Embodiment 6.

FIG. 19 is a schematic diagram of an infrared sensor and a mirror of the air-conditioning control apparatus according to Embodiment 6.

FIG. 20 is an enlarged view of an actuator of the air-conditioning control apparatus according to Embodiment 6.

FIG. 21 is a perspective view of the mirror of the air-conditioning control apparatus according to Embodiment 6.

FIG. 22 is a schematic diagram of an infrared sensor and a mirror according to Exemplary Embodiment 8.

### DETAIL DESCRIPTION OF EXEMPLARY EMBODIMENTS

Control apparatuses for vehicles according to Embodiments will be described below using the drawings. It should be noted that, in the drawings, the same constituent elements are assigned the same reference numerals, and description thereof are omitted. Furthermore, the constituent elements in Embodiments may be optionally combined within a consistent range.

### Exemplary Embodiment 1

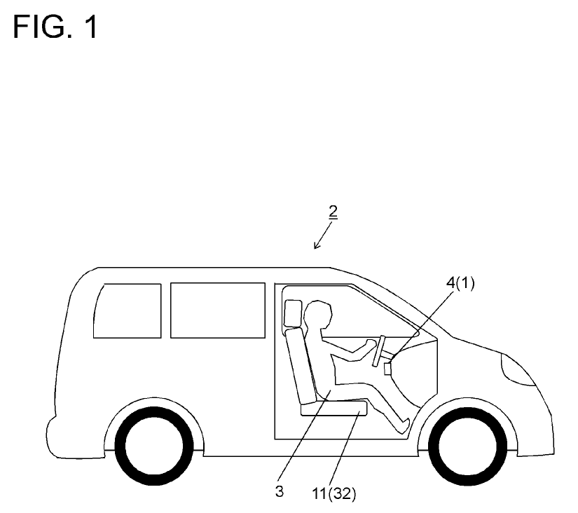

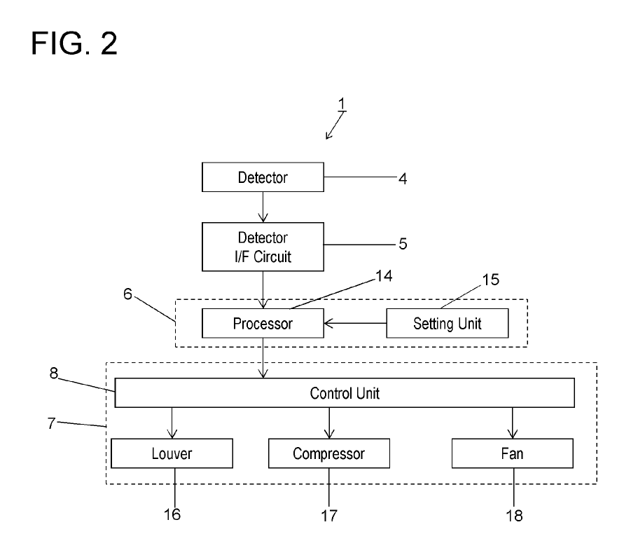

FIG. 1 illustrates vehicle 2 having air-conditioning control apparatus 1 according to Exemplary Embodiment 1 installed thereto. FIG. 2 is a block diagram of air-conditioning control apparatus 1.

Air-conditioning control apparatus 1 according to Embodiment 1 includes detector 4 installed in vehicle 2 for detecting a temperature distribution of at least one occupant 3 in a cabin, detector interface (I/F) circuit 5 connected to detector 4; processing unit 6 for estimating a thermal sensation based on the output of detector 4, and control unit 8 for controlling air conditioner 7 according to the estimation result of the thermal sensation.

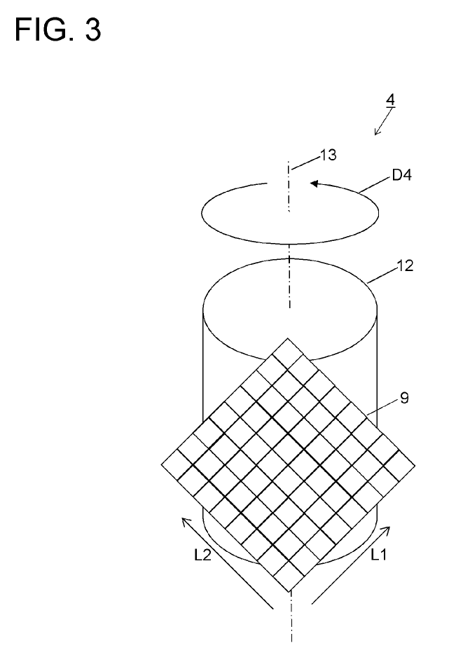

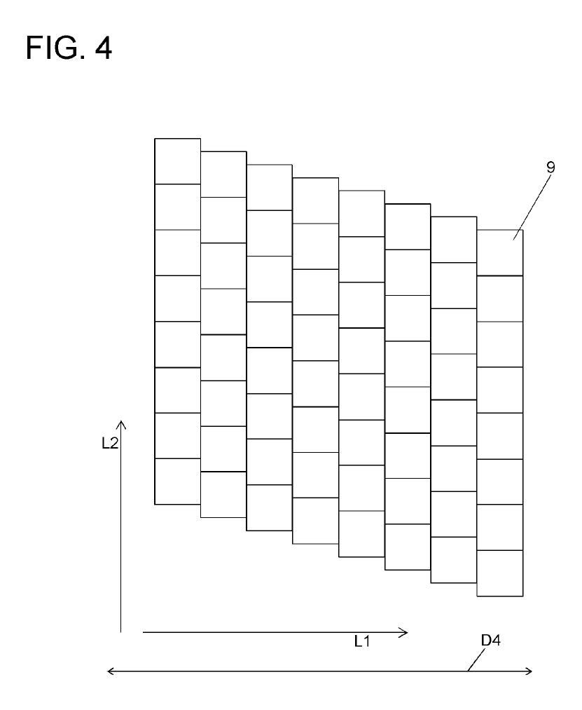

FIG. 3 illustrates detector 4. Detector 4 includes an infrared sensor. The infrared sensor includes a thermal infrared detector in which a temperature-sensitive element is embedded. The temperature-sensitive element is implemented by a thermoelectric converter that includes a thermopile for converting thermal energy of infrared rays emitted from an object into electric energy. In the infrared sensor, an (a×b) number of pixel units 9 (non-contact infrared detection elements) each including a temperature-sensitive element and a MOS transistor for extracting an output voltage of the temperature-sensitive element are arranged in a two-dimensional array with a a-number of rows and a b-number of columns on one surface of a semiconductor substrate. In accordance with Embodiment 1, pixel units 9 are arranged in eight rows and eight columns. In detector 4, any sensor capable of obtaining a temperature distribution may be used. The infrared sensor provides an inexpensive and accurate temperature sensor. In detector 4, pixel units 9 are arranged so that row direction L1 and column direction L2 of pixel units 9 are tilted with respect to scanning direction D4 of detector 4. This arrangement provides a higher the resolution of an obtained thermal image than pixel units 9 in which row direction L1 of pixel units 9 is identical to scanning direction D4 of detector 4. FIG. 4 illustrates another detector 4. In the case where pixel units 9 are arranged so that scanning direction D4 of detector 4 is identical to row direction L1 of pixel units 9, as illustrated in FIG. 4, the columns of pixel units 9 are deviated from each other in column direction L2 for each row. This arrangement allows row direction L1 of pixel units 9 to be identical to scanning direction D4 of detector 4, and provides a higher resolution of an obtained thermal image than a case in which pixel units 9 are arranged in the form of a square or a rectangle.

Detector 4 is installed inside the font part of vehicle 2 and between driver seat 10 and front passenger seat 11 so that occupant 3 on driver seat 10, front passenger seat 11, or other seats, who is an object for detection, can be detected. When detector 4 receives solar radiation, detector 4 may possibly make a detection error, and therefore, detector 4 is arranged in a place in which detector 4 is unlikely to receive solar radiation, so that detector 4 can detect occupant 3 accurately at any time. The infrared sensor is connected to scanning unit 12 including a motor and other components, and performs scanning on rotation axis 13 so that the whole body of occupant 3 can be within a detection area of detector 4. The infrared sensor performs scanning and combining obtained temperature distributions in detector I/F circuit 5 to produce a temperature distribution, and provides a thermal image with high resolution. This configuration allows the temperature of occupant 3 to be detected accurately, and increases the accuracy of determination of occupant 3. Detector 4 is not necessarily installed in the front part of vehicle 2, and may be installed in a place, such as a pillar or ceiling, in which detector 4 is less affected by solar radiation and can detect occupant 3.

Processing unit 6 is implemented by a microcomputer. Processing unit 6 includes processor 14 for estimating a thermal sensation based on a thermal image obtained in detector 4 and a setting unit 15 for setting a threshold value used for the estimation of the thermal sensation.

Processor 14 detects occupant 3 and a background from a thermal image obtained by detector 4, and estimates the thermal sensation of occupant 3 by making a comparison with a threshold value having been preset in setting unit 15. The thermal sensation indicates whether occupant 3 feels hot or cold, and a scale of thermal sensation has been set according to how occupant 3 feels, such as “hot”, “very hot”, “cold”, “very cold”, and “comfortable”.

Control unit 8 controls air conditioner 7 according to the estimation result of a thermal sensation. In the case where the estimation result of a thermal sensation is “hot”, control unit 8 exerts control, for example, lowers a set temperature for cooling or increases the volume of air flow. In contrast, in the case where the estimation result of a thermal sensation is “cold”, control unit 8 exerts control, for example, increases a set temperature for heating or increases the volume of air flow. When the thermal sensation of occupant 3 becomes “comfortable”, control unit 8 controls air conditioner 7 so as to maintain the thermal sensation “comfortable”.

Air conditioner 7 includes louver 16, compressor 17, and fan 18 which are connected to control unit 8. According to the output of processor 14, control unit 8 controls louver 16, compressor 17, and fan 18 so as to control air conditioner 7.

A method of detection with air-conditioning control apparatus 1 will be described below.

Detector 4 performs scanning in two scanning modes, that is, a high-speed swing mode and a low-speed swing mode. In the high-speed swing mode, detector 4 performs scanning every 60 degrees, whereas, in the low-speed swing mode, detector 4 performs scanning every 1 degree. Detector 4 performs the scanning within scannable range R of 180 degrees.

Air-conditioning control apparatus 1 increases accuracy in the estimation of the thermal sensation of occupant 3a by increasing the resolution of the thermal image of occupant 3. When detailed scanning is performed by detector 4 in the low-speed swing mode, a thermal image with high resolution can be obtained. However, in the case where detector 4 performs scanning in the low-speed swing mode every time for the purpose of enhancing the resolution, it takes a longer time for detector 4 to scan the whole of scannable range R. In accordance with Embodiment 1, in the case where the refresh rate of the infrared sensor is, for example, 100 msec, it takes 36 seconds for detector 4 to reciprocate once. A longer time is spent to scan a place in which occupant 3 does not exist and a thermal image of which with high resolution is not required. Consequently, more waste is caused in the estimation of a thermal sensation. In this case, if detector 4 is directed in a direction in which occupant 3 does not exist at the time of a transient response immediately after occupant 3 gets in the vehicle, the transient response of occupant 3 cannot be responded. By switching appropriately between the high-speed swing mode and the low-speed swing mode, air-conditioning control apparatus 1 enhances the resolution of a thermal image of occupant 3 while shortening the scanning time of detector 4.

In the air-conditioning control described in PTL 1, the viewing angle of a temperature sensor is small. If this air-conditioning control is applied to air-conditioning control described in PTLs 2 to 5, scanning speed in the air-conditioning control described in PTLs 2 to 5 becomes slower.

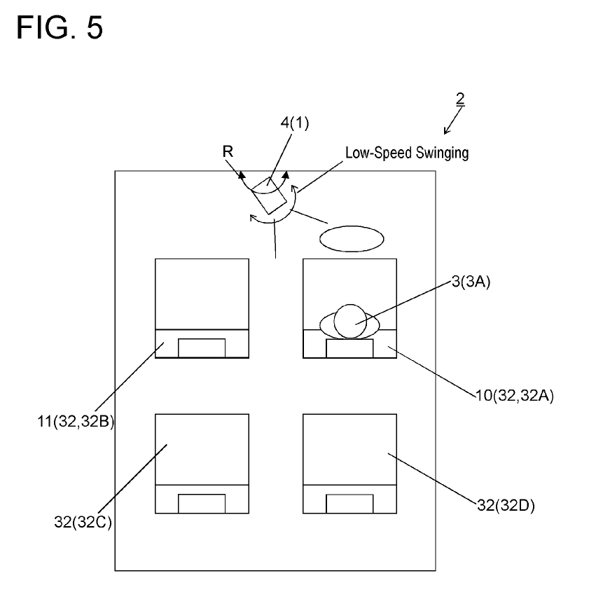

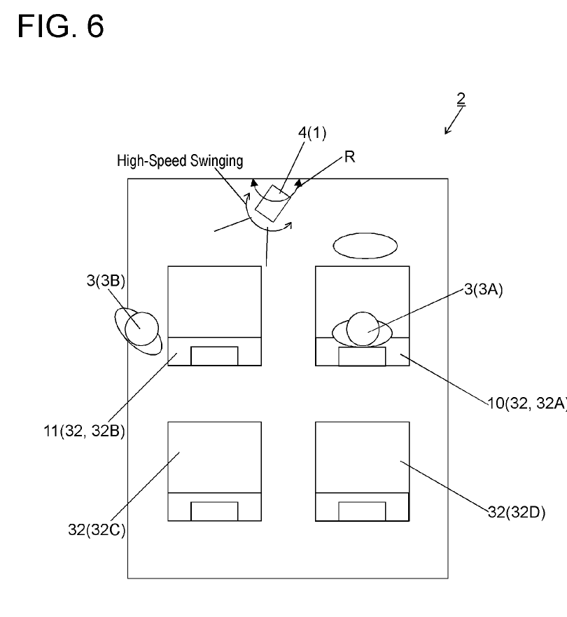

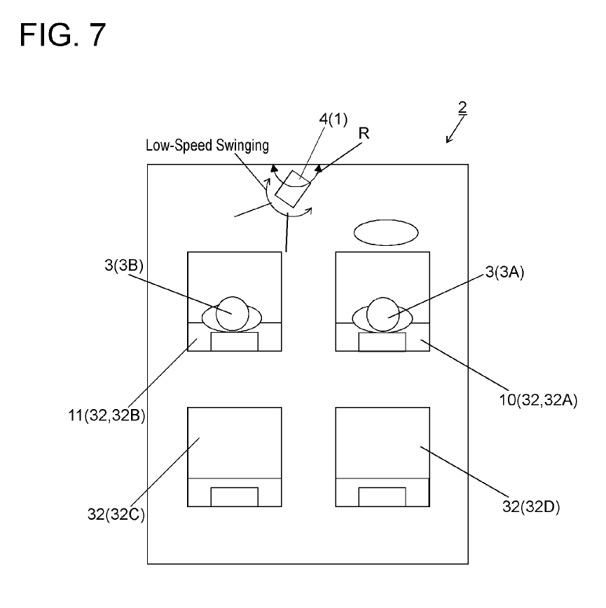

FIGS. 5, 6, and 7 illustrate a method of scanning with detector 4. First, as illustrated in FIG. 5, a detailed image of an area around driver seat 10 is captured in the low-speed swing mode. In this manner, air-conditioning control apparatus 1 operates so that the thermal sensation of driver 3A (occupant 3) can be estimated in a short time. Next, as illustrated in FIG. 6, a rough image of the whole of scannable range R of detector 4 is captured in the high-speed swing mode. This configuration allows further occupant 3B out of occupants 3 other than driver 3A to be detected in a short time. As illustrated in FIG. 7, in the case where occupant 3B other than driver 3A is detected at a place, such as front passenger seat 11, other than driver seat 10, the mode of scanning by detector 4 is changed into the low-speed swing mode. An image of an area around occupants 3 detected in the high-speed swing mode is captured in the low-speed swing mode. This configuration allows the thermal sensation of occupant 3B other than driver 3A to be estimated. Thus, an image of an area in which occupants 3 exist is captured in the low-speed swing mode, whereas an image of an area in which occupants 3 do not exist is captured in the high-speed swing mode, and thereby, only the thermal image of occupant 3 which is required for estimating the thermal sensation is taken as a high-resolution thermal image. This configuration decreases the scanning time of detector 4 without decreasing accuracy in the estimation of a thermal sensation. When the scanning time of detector 4 is shorter, air conditioner 7 can be more finely controlled in response to variations in thermal sensation, and consequently improving the comfortability of occupant 3.

As described above, when the high-speed swing mode and the low-speed swing mode are used in combination, the scanning time of detector 4 is remarkably shorter. For example, when an area around occupant 3 is scanned at an angle of 15 degrees in the low-speed swing mode, it takes approximately 3 seconds for detector 4 to reciprocate once. Since it takes 300 msec to scan scannable range R of detector 4 in the high-speed swing mode, the thermal sensation of occupant 3 can be estimated in approximately 3.3 seconds after the scanning mode of detector 4 is shifted to the high-speed swing mode. Time to estimate a thermal sensation can be shortened by about 33 seconds, compared with a case in which scanning is performed only in the low-speed swing mode.

In accordance with Embodiment 1, the scanning angle of detector 4 in the high-speed swing mode is 60 degrees and the scanning angle of detector 4 in the low-speed swing mode is 1 degree, but the scanning angle is not limited to these. For example, the scanning angle in the high-speed swing mode may be 45 degrees and the scanning angle in the low-speed swing mode may be 2 degrees. As described above, the scanning angle of detector 4 in each of the modes may be suitably changed according to operating conditions of air-conditioning control apparatus 1.

Scannable range R of detector 4 is 180 degrees, but not limited to this, and scannable range R of detector 4 may be suitably changed according to operating conditions of air-conditioning control apparatus 1, for example, scannable range R may be 150 degrees.

The number of pixels of the infrared sensor used for capturing an image may be changed as needed. By reducing the number of pixels used for capturing an image, the processing speed of processing unit 6 can be increased.

The reduction in the number of pixels may be performed in any of the swing modes. For example, when the number of pixels used for capturing an image in the high-speed swing mode is reduced, the processing speed of processing unit 6 can be increased. In the high-speed swing mode, a thermal image with high resolution is not required, and therefore, time for thermal sensation processing can be shortened without a decrease in detection accuracy.

### Exemplary Embodiment 2

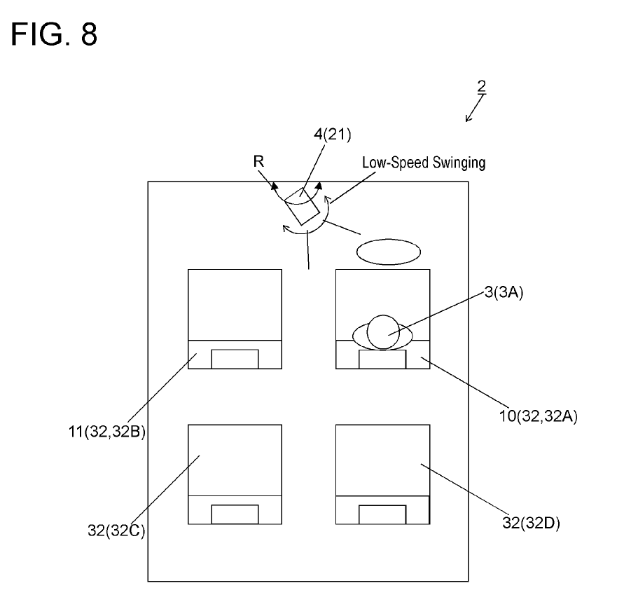

FIGS. 8 to 10 illustrate a method of scanning with detector 4 of air-conditioning control apparatus 21 according to Exemplary Embodiment 2. In FIGS. 8 to 10, components identical to those of air-conditioning control apparatus 1 shown in FIGS. 1 to 7 are denoted by the same reference numerals. Besides the high-speed swing mode and the low-speed swing mode, air-conditioning control apparatus 21 according to Embodiment 2 operates in an occupant detection mode as a mode of scanning with detector 4. In the occupant detection mode, the scanning of detector 4 stops at the center of scannable range R of detector 4 to obtain a thermal image over a wide area. In the occupant detection mode, detector 4 detects whether or not occupant 3 is inside vehicle 2.

A method of detection with air-conditioning control apparatus 21 according to Embodiment 2 will be described below.

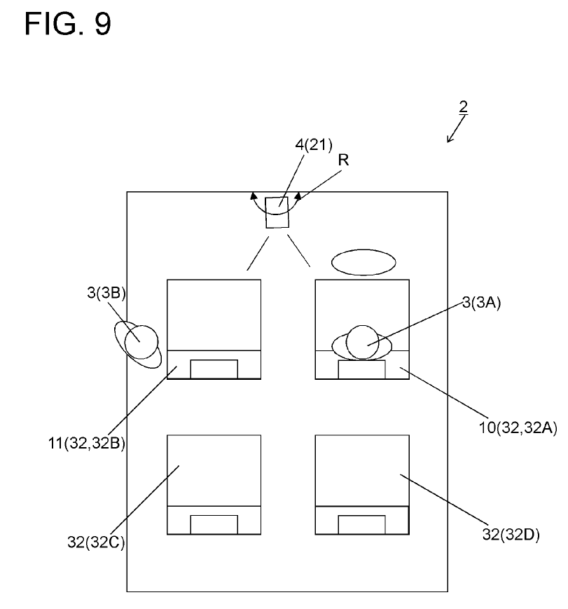

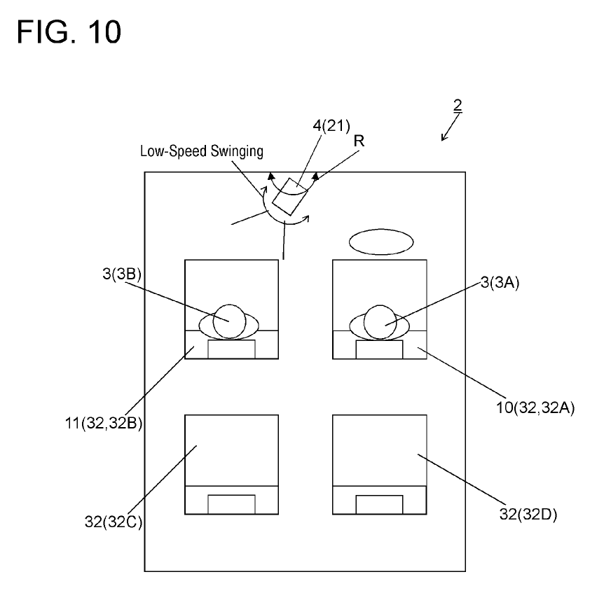

First, as illustrated in FIG. 8, an image of an area around driver 3A out of occupants 3 is captured in the low-speed swing mode. When the thermal image of driver 3A is obtained, the mode is shifted to the occupant detection mode, as illustrated in FIG. 9. In the occupant detection mode, occupant 3 (3B) entering into the field of view of detector 4 is detected. When occupant 3B is detected in the occupant detection mode, the mode is shifted to the high-speed swing mode and detector 4 is directed toward occupant 3B at high speed. When detector 4 is directed toward occupant 3B, the mode is shifted to the low-speed swing mode as illustrated in FIG. 10. When the mode is shifted to the low-speed swing mode, an image of an area around occupant 3B is captured at low speed. When the thermal image of the occupant with high resolution is obtained at the low-speed swing mode, the mode is shifted to the occupant detection mode, again. After that, the high-speed swing mode, the low-speed swing mode, and the occupant detection mode are repeated. This operation can eliminate a time to cause detector 4 to uselessly perform scanning, and consequently, a thermal image with high resolution can be obtained in a short time.

Scanning with detector 4 in the case where occupants 3 are detected in the occupant detection mode will be described below.

First, occupants 3 are detected in the occupant detection mode. When occupants 3 are detected, the mode is shifted to the high-speed swing mode and detector 4 is directed at high speed toward first occupant 3 (for example, driver 3A) out of occupants 3. When detector 4 is directed toward first occupant 3, the mode is shifted to the low-speed swing mode. When an image of an area around first occupant 3 is captured in the low-speed swing mode, the mode is shifted to the high-speed swing mode and detector 4 is directed toward second occupant 3 (for example, occupant 3B) out of occupants 3. When an image of an area around second occupant 3 is captured, detector 4 is directed toward third occupant 3 out of occupants 3 in the high-speed swing mode. Until the capturing of images of all occupants 3 detected is completed, the mode continues to be shifted between the high-speed swing mode and the low-speed. After the capturing of images of all occupants 3 is completed, the mode is shifted to the occupant detection mode. As described above, the thermal images of all occupants 3 are obtained and then the thermal sensations of all occupants 3 are estimated, thus providing the thermal images of all occupants 3 with high resolution in a short time.

This operation may be performed such that, every time the capturing of an image of an area around each occupant 3 in the low-speed swing mode is completed, the mode is shifted to the occupant detection mode, and after the estimation of the thermal sensation of one occupant 3 is completed, the thermal sensation of subsequent occupant 3 is estimated. Also in this case, the thermal sensations of occupants 3 can be estimated with high accuracy in a short time.

### Exemplary Embodiment 3

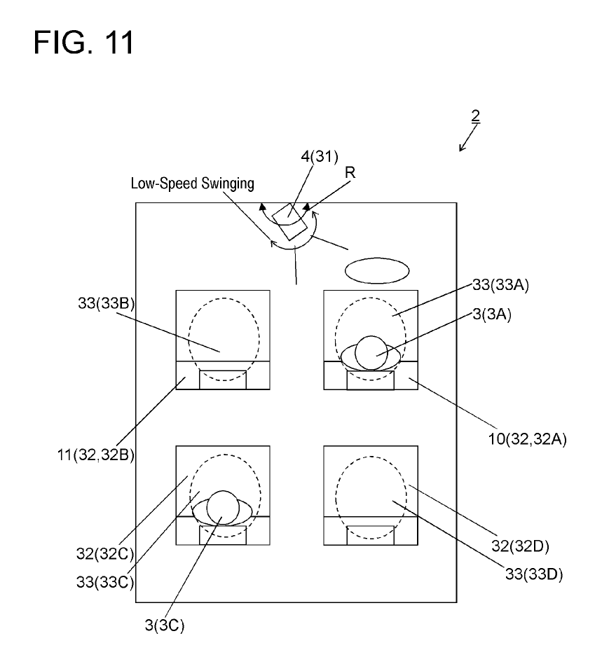

FIGS. 11 to 13 illustrate a method of scanning with detector 4 of air-conditioning control apparatus 31 according to Exemplary Embodiment 3. In FIGS. 11 to 13, components identical to those of air-conditioning control apparatus 1 described in FIGS. 1 to 7 are denoted by the same reference numerals. Vehicle 2 includes plural seats 32 (32A to 32D). In air-conditioning control apparatus 31 according to Embodiment 3, weight sensor 33 is provided under each seat 32. Specifically, each of weight sensors 33 (33A, 33B, 33C, 33D) are provided under respective on of seats 32 (32A, 32B, 32C, 32D). Each of weight sensors 33 (33A, 33B, 33C, 33D) can detect occupant 3 sitting on respective one of seats 32 (32A, 32B, 32C, 32D).

A method of detection with air-conditioning control apparatus 31 according to Embodiment 3 will be described below.

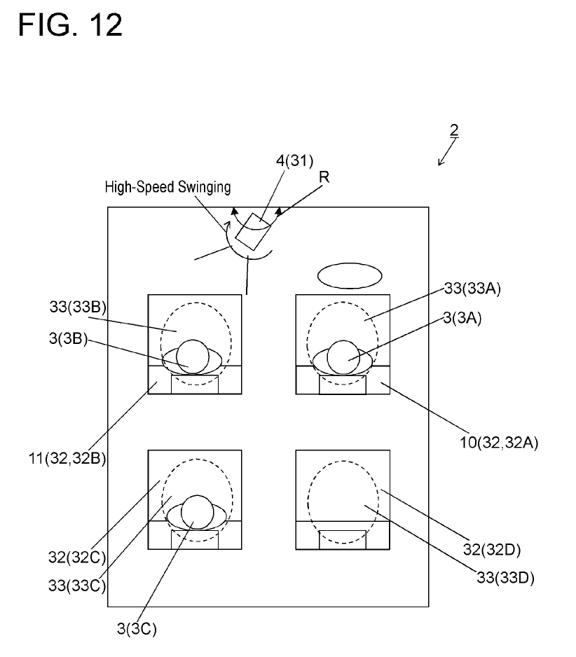

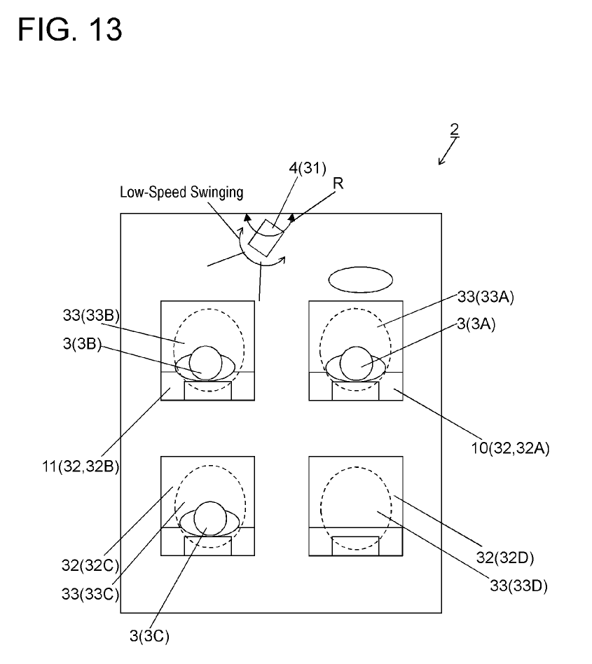

First, as illustrated in FIG. 11, detector 4 captures an image of an area around driver seat 10, i.e., seat 32A out of plural seats 32 in the low-speed swing mode. When weight sensor 33B out of weight sensors 33 (33A to 33D) detects a change in weight, detector 4 is directed in the high-speed swing mode in a direction in which weight sensor 33B detects the weight, as illustrated in FIG. 12. In the case where it is determined based on a thermal image obtained in the high-speed swing mode that the weight detected by weight sensor 33 belongs to occupant 3 (3B), detector 4 captures an image of an area around occupant 3 (3B) in the low-speed swing mode, as illustrated in FIG. 13. Furthermore, when weight sensor 33C out of weight sensors 33 (33A to 33D) detects a change in weight, detector 4 is directed in the high-speed swing mode in a direction in which weight sensor 33C detects the weight. In the case where it is determined based on a thermal image obtained in the high-speed swing mode that the weight detected by weight sensor 33C belongs to occupant 3 (3C), detector 4 captures an image of an area around occupant 3 (3C) in the low-speed swing mode. In the case where it is determined based on a thermal image obtained in the high-speed swing mode that the weight detected by weight sensor 33 belongs to something such as luggage other than occupant 3, an image of an area around driver 3A is captured in the low-speed swing mode, and air conditioner 7 is controlled according to the thermal sensation of driver 3A. In this operation, only when a change in the weight of seat 32 occurs, the mode is shifted to the high-speed swing mode, and thus, a thermal sensation can be estimated accurately in a short time. Furthermore, as long as no change in the weight of seat 32, an image of an area around driver 3A is continuously captured in the low-speed swing mode, and thus, air conditioner 7 can be controlled precisely according to the thermal sensation of driver 3A, thereby improving the comfortability of driver 3A. Furthermore, since the detection of the weight of occupant 3 is performed by weight sensor 33, also when occupant 3 moves inside vehicle 2, detector 4 can follow the movement quickly.

### Exemplary Embodiment 4

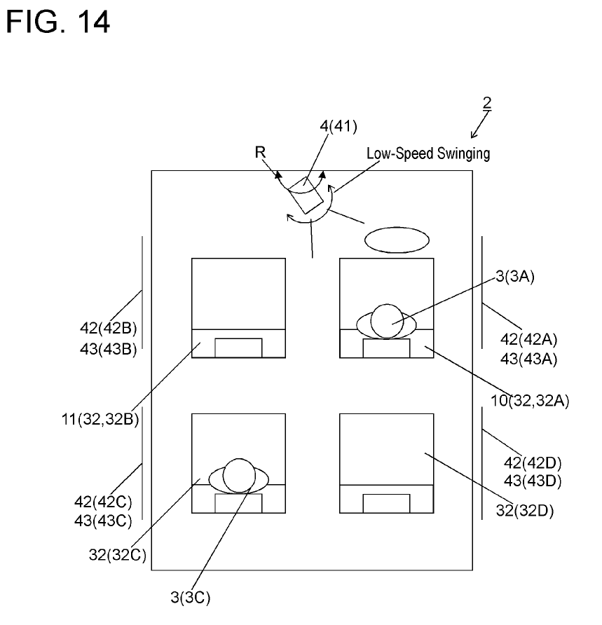

FIGS. 14 to 16 illustrate a method of scanning with detector 4 of air-conditioning control apparatus 41 according to Exemplary Embodiment 4. In FIGS. 14 to 16, components identical to those of air-conditioning control apparatus 1 described in FIGS. 1 to 7 are denoted by the same reference numerals. Vehicle 2 includes plural doors 42 (42A to 42D). In air-conditioning control apparatus 41 according to Embodiment 4, each of doors 42 is provided with respective one of opening-closing sensors 43. Opening-closing sensors 43 (43A to 43D) detect the opening and closing of doors 42 (42A to 42D), respectively. Opening-closing sensor 43 can detect occupants 3 getting into vehicle 2.

A method of detection with air-conditioning control apparatus 41 of Embodiment 4 will be described below.

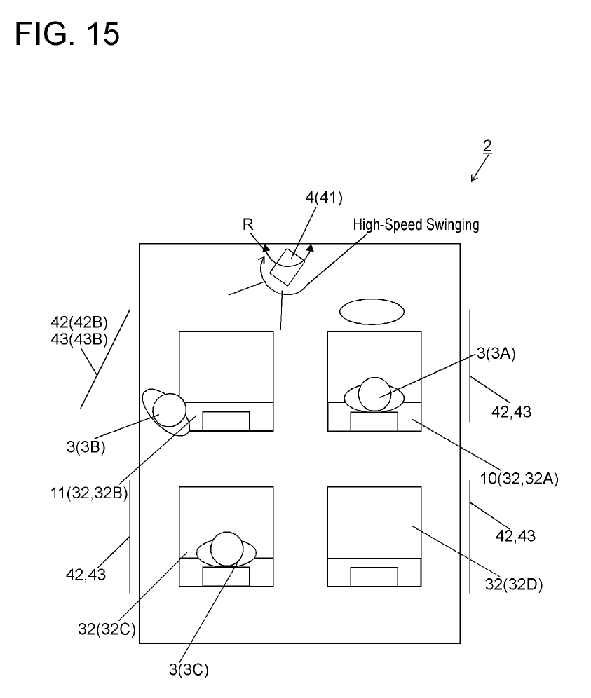

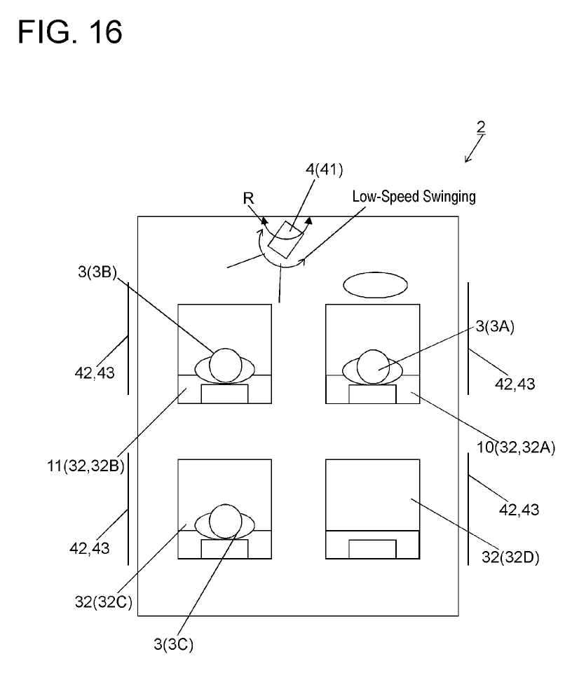

First, as illustrated in FIG. 14, an image of an area around driver seat 10 is captured in the low-speed swing mode. As illustrated in FIG. 15, when opening-closing sensor 43 detects the opening and closing of door 42 (42B), detector 4 is directed in the high-speed swing mode in a direction in which opening-closing sensor 43 detects the opening and closing of door 42 (42B). In the case where it is determined from a thermal image obtained in the high-speed swing mode that occupant 3B gets into vehicle 2, an image of an area around occupant 3B is captured in the low-speed swing mode, as illustrated in FIG. 16. In contrast, in the case where it is determined based on a thermal image obtained in the high-speed swing mode that no occupant 3 gets into vehicle 2, an image of an area around driver 3A is captured in the low-speed swing mode, and air conditioner 7 is controlled according to the thermal sensation of driver 3A. With this operation, only when occupant 3 for seat 32 gets into vehicle 2, the mode is shifted to the high-speed swing mode, and thus, a thermal sensation can be estimated accurately in a short time. Furthermore, as long as the opening and closing of door 42 is not performed, an image of an area around driver 3A is continuously captured in the low-speed swing mode, and thus, air conditioner 7 can be controlled precisely according to the thermal sensation of driver 3A. Consequently, the comfortability of driver 3A can be improved.

### Exemplary Embodiment 5

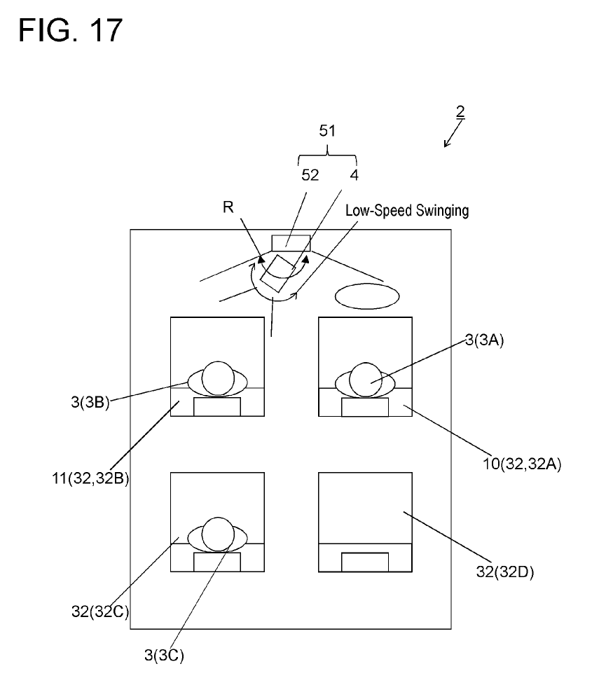

FIG. 17 illustrates a method of scanning with detector 4 of air-conditioning control apparatus 51 according to exemplary Embodiment 5. In FIG. 17, components identical to those of air-conditioning control apparatus 1 described in FIGS. 1 to 7 are denoted by the same reference numerals. Besides detector 4, air-conditioning control apparatus 51 according to Embodiment 5 further includes detector 52. Detector 52 includes the same type of an infrared sensor as that of detector 4. Detector 52 is fixed in the front part of vehicle 2 so that driver seat 10 and front passenger seat 11 enter into the field of view of detector 52.

A method of detection with air-conditioning control apparatus 51 of Embodiment 5 will be described below.

When detector 52 detects occupant 3 (3B), detector 4 is directed toward occupant 3 (3B) in the high-speed swing mode. When detector 4 is directed toward occupant 3 (3B), an image of an area around occupant 3 (3B) is captured in the low-speed swing mode. As described above, in the case where occupant 3 is not detected by detector 52, detector 4 does not perform scanning. Only in the case where occupant 3 is detected by detector 52, detector 4 is directed toward occupant 3. Thus, a thermal image obtained with detector 4 can be used only for the estimation of a thermal sensation. This operation eliminates a time during which the thermal sensation of occupant 3 is not estimated, consequently improving the comfortability of occupant 3.

Detector 52 is described as including the same type of an infrared sensor as that of detector 4, but, detector 52 may be a monocular pyroelectric sensor with a single lens. In this case, when detector 52 detects the movement of occupant 3, detector 4 scans the whole of scannable range R in the high-speed swing mode to detect whether occupant 3 exists or not. This operation allows a thermal sensation to be estimated accurately in a short time, consequently improving the comfortability of occupant 3.

### Exemplary Embodiment 6

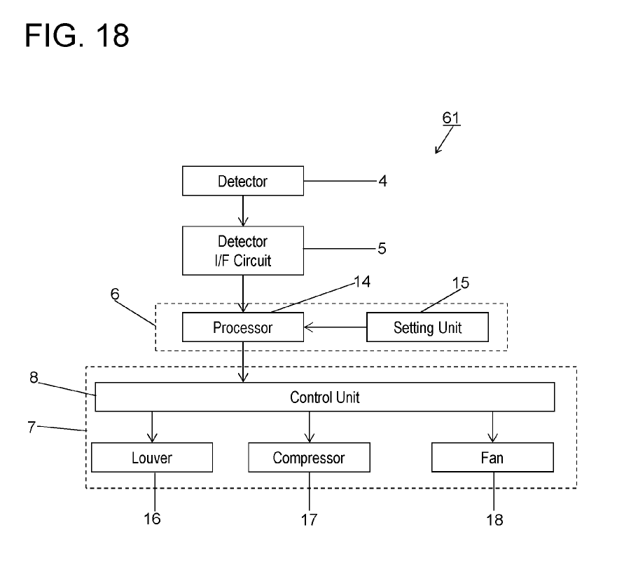

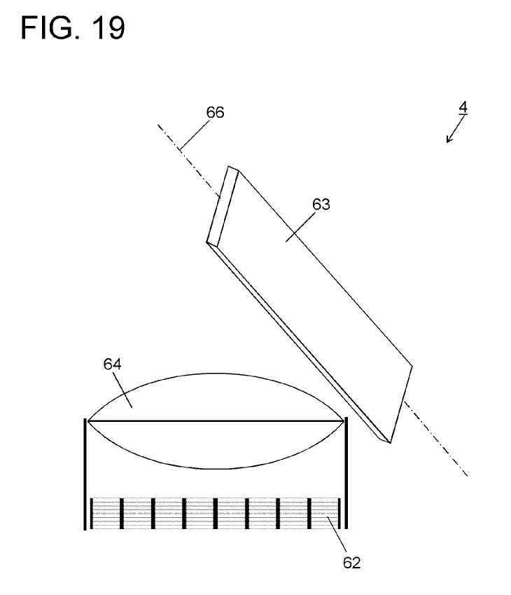

FIG. 18 is a block diagram of air-conditioning control apparatus 61 according to exemplary Embodiment 6. FIG. 19 illustrates detector 4 of air-conditioning control apparatus 61 according to Embodiment 6.

As illustrated in FIG. 19, in air-conditioning control apparatus 61 according to Embodiment 6, detector 4 does not perform scanning. Instead, mirror 63 is arranged in front of infrared sensor 62 of detector 4, and mirror 63 performs scanning to obtain a thermal image over a wide area. In detector 4 according to Embodiment 6, lens 64 is provided between infrared sensor 62 and mirror 63.

In the case where infrared sensor 62 is driven with a motor, the motor is driven all the time, which results in the silence and durability of the motor becoming an issue. Detector 4 which is inside the small space of vehicle 2 has no option but to be installed at a position in which detector 4 comes into the field of view of occupant 3. In the case where detector 4 is installed within the field of view of particularly driver 3A out of occupants 3, driver 3A may feel detector 4 obtrusive. In air-conditioning control apparatus 61 according to Embodiment 6, scanning is performed not by infrared sensor 62 but by mirror 63, and thus, the silence and durability of detector 4 is improved, and furthermore, occupant 3 is prevented from feeling detector 4 obtrusive.

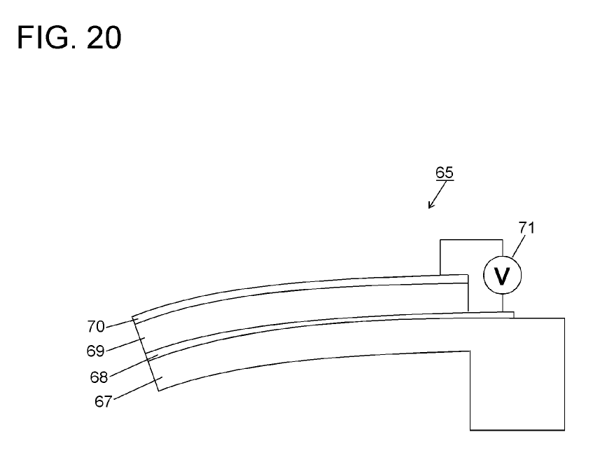

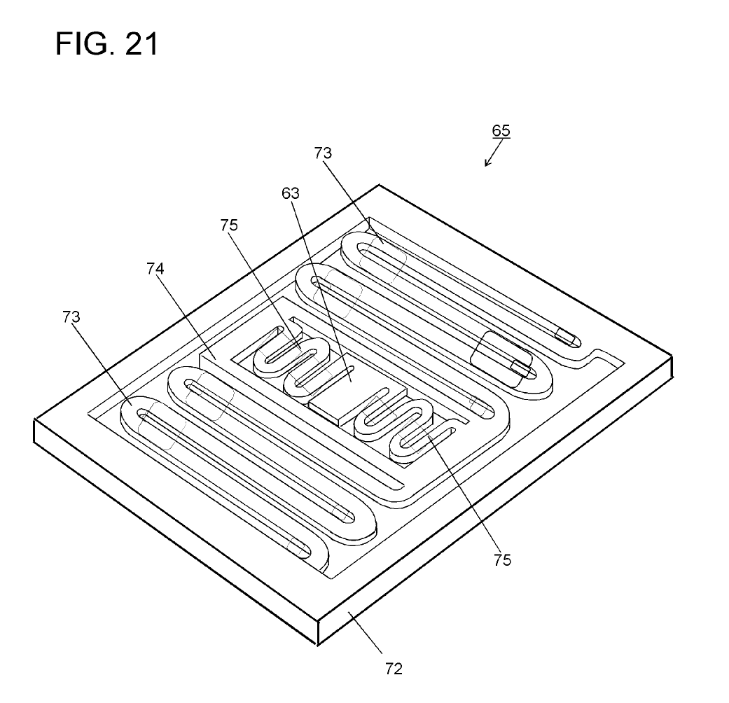

FIG. 19 illustrates the relationship between infrared sensor 62 and mirror 63 according to Embodiment 6. FIG. 20 is an enlarged view of actuator 65 for driving mirror 63. FIG. 21 is a perspective view of mirror 63. Mirror 63 is tilted in front of infrared sensor 62. Mirror 63 rotates about rotation axis 66. Mirror 63 is driven by actuator 65 according to the refresh rate of infrared sensor 62. Actuator 65 is provided on elastic body 67, such as silicon, and includes lower electrode 68 provided on elastic body 67, piezoelectric body 69 provided on lower electrode 68, and upper electrode 70 provided on piezoelectric body 69. Upper electrode 70 and lower electrode 68 are connected to power source 71. Actuator 65 is deformed and bent due to piezoelectric effect of piezoelectric body 69, thereby causing mirror 63 to perform scanning. Actuator 65 further includes beam 73 provided inside fixed part 72, frame 74 provided inside beam 73, beam 75 provided inside frame 74, and mirror 63 supported by beam 75. The resonance frequency of beam 73 is identical to that of beam 75.

This configuration improves silence and durability of detector 4. Scanning and detection can be separately performed. This configuration increases flexibility in the installation position of detector 4, accordingly allowing detector 4 to be more easily installed at a position at which a driver does not feel detector 4 obtrusive. Thus, the driver does not feel detector 4 obtrusive, consequently improving the safety of driving. Furthermore, mirror 63 performs scanning according to the refresh rate of infrared sensor 62, and provides the same thermal image as that in the case of scanning with infrared sensor 62, and thus, the silence, durability, and safety can be improved without a decrease in accuracy in the estimation of a thermal sensation. Furthermore, actuator 65 including piezoelectric body 69 can be manufactured inexpensively

When an angle of scanning with mirror 63 is changed according to a scanning mode of detector 4, a time to estimate a thermal sensation can be shortened, as in Embodiment 1.

In accordance with Embodiment 6, actuator 65 is piezoelectrically driven, but, actuator 65 may be electrostatically driven. Even when actuator 65 is electrostatically driven, the same effect as in the case where actuator 65 is driven by a piezoelectric body can be achieved. Alternatively, actuator 65 may be driven by a Lorentz force due to a current and a magnetic field. With this, the same effect as in the case where actuator 65 is driven by a piezoelectric body can be achieved, and furthermore, such large driving force allows an increase in the amplitude of actuator 65.

When pixel units 9 of infrared sensor 62 are arranged as illustrated in FIG. 4, the resolution of an obtained thermal image can be increased, compared with a case in which pixel units 9 of the infrared sensor are arranged in the form of a square or a rectangle.

In accordance with Embodiment 6, imaging lens 64 is provided between infrared sensor 62 and mirror 63, but, imaging lens 64 may be formed unitarily with mirror 63. Mirror 63 formed unitarily with imaging lens 64 allows the infrared sensor side of imaging lens 64 to be uses as a transmission window not having a light condensing function.

Mirror 63 may be made of a photonic crystal with a modulatable refractive index. The photonic crystal allows a wide range of infrared rays to be condensed, and allows the deflection angle of mirror 63 scanning to be smaller.

Actuator 65 and a motor allow mirror 63 to perform scanning. Although it is hard for the actuator to make the deflection angle larger, but, when a hybrid of actuator 65 and a motor is used, different scanning methods can be used depending on a deflection angle, for example, scanning at a large deflection angle of 20 degrees or more is performed with the motor, whereas scanning at a smaller deflection angle is performed with actuator 65. With this, scanning at a large deflection angle can be performed, and the durability of the motor is improved.

### Exemplary Embodiment 7

An air-conditioning control apparatus according to Exemplary Embodiment 7 is different from the air-conditioning control apparatus according to Embodiment 6 in the resonance frequencies of beams 73 and 75 of mirror 63. The shape of actuator 65 is identical to that of Embodiment 6.

In the air-conditioning control apparatus according to Embodiment 7, beam 73 of actuator 65 has a first resonance frequency, whereas beam 75 thereof has a second resonance frequency. Beams 73 and 75 are made of silicon. Beams 73 and 75 are piezoelectrically driven. Beam 73 is driven at the first resonance frequency, whereas beam 75 is driven at the second resonance frequency. The first resonance frequency is higher than the second resonance frequency. Table 1 shows difference of twisting of the beams having different thicknesses, and shows the resonance frequencies and deflection angles.

TABLE 1

| | | | |
|---|---|---|---|
| Thickness of Beam | Thin | Medium | Thick |
| Resonance Frequency | High | Medium | Low |
| Twisting Angle | Small | Medium | Large |

As shown in Table 1, as the thickness of a beam is larger, the resonance frequency thereof is lower and the twisting angle is larger. Hence, the thicknesses of beams are adjusted to allow the first resonance frequency to be different from the second resonance frequency.

Beams 73 and 75 having different resonance frequencies of actuator 65 allows image data to be obtained at the refresh rate of infrared sensor 62 at both ends of twisting angles at a constant angle.

### Exemplary Embodiment 8

An air-conditioning control apparatus according to exemplary Embodiment 8 is different from the air-conditioning control apparatus according to Embodiment 6 in the shape of mirror 63.

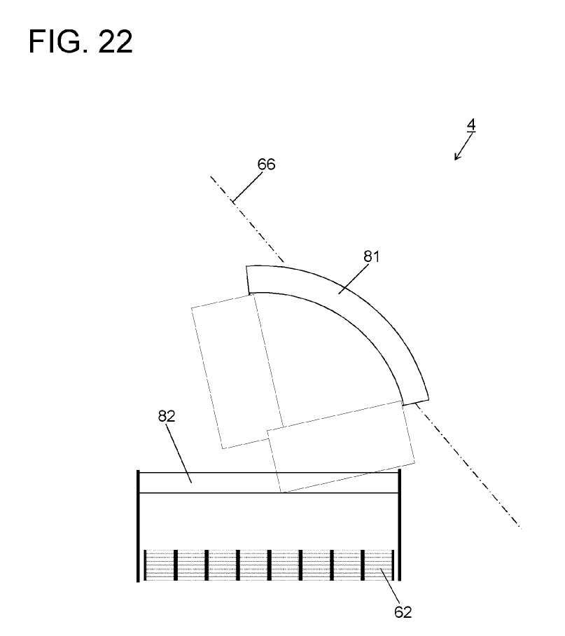

FIG. 22 illustrates the relationship between infrared sensor 62 and mirror 81 according to Embodiment 8. In accordance with Embodiment 8, mirror 81 is made of a parabolic mirror. Transparent window 82 is provided between infrared sensor 62 and mirror 81.

In the case that a parabolic mirror is used as mirror 81, infrared ray reflected on mirror 81 is concentrated to the infrared sensor. Thus, it is not necessary to use an imaging lens, hence providing an inexpensive air-conditioning control apparatus.

### INDUSTRIAL APPLICABILITY

An air-conditioning control apparatus according to the present disclosure reduces a scanning time of a detector, and is therefore particularly suitable for air conditioners for, e.g. vehicles.

### REFERENCE MARKS IN THE DRAWINGS

1, 21, 31, 41, 51, 61 air-conditioning control apparatus
2 vehicle
3 occupant
4 detector (first detector)
5 detector I/F circuit (first detector I/F circuit)
6 processing unit
7 air conditioner
8 control unit
9 pixel unit
10 driver seat
11 front passenger seat
12 scanning unit
13, 66 rotation axis
14 processor
15 setting unit
16 louver
17 compressor
18 fan
32 seat
33 weight sensor
42 door
43 opening-closing sensor
52 detector (second detector)
62 infrared sensor
63, 81 mirror
64 imaging lens
65 actuator
67 elastic body
68 lower electrode
69 piezoelectric body
70 upper electrode
71 power source
72 fixed part
73 beam (first beam)
74 frame
75 beam (second beam)
82 transmission window
L1 row direction
L2 column direction
R scannable range

1. An air-conditioning control apparatus configured to control an air conditioner installed to a vehicle, the air-conditioning control apparatus comprising:
a first detector that obtains a thermal image of an occupant in the vehicle and obtains a temperature distribution of the thermal image;
a processing unit that estimates a thermal sensation of the occupant from the temperature distribution obtained by the first detector; and
a control unit for controlling the air conditioner according to the estimated thermal sensation, wherein
upon detecting the occupant, the first detector captures a thermal image of an area around the occupant.

2. The air-conditioning control apparatus according to claim 1, wherein
the vehicle includes a seat for the occupant to sit on,
the air-conditioning control apparatus further comprises a weight sensor provided in the seat of the vehicle, and
upon detecting a change in a weight of the seat, the a weight sensor determines whether or not the occupant sits on the seat.

3. The air-conditioning control apparatus according to claim 1, wherein
the vehicle includes a door,
the air-conditioning control apparatus further comprises an opening-closing sensor for detecting opening and closing of the door of the vehicle, and
upon detecting opening and closing of the door, the processing unit determines whether or not the occupant has got into the vehicle.

4. The air-conditioning control apparatus according to claim 1, further comprising
a second detector directed toward a center of the vehicle, wherein
when the second detector detects the occupant, the first detector captures an image of an area around the occupant.

5. The air-conditioning control apparatus according to claim 1, wherein
the first detector includes an infrared sensor and a scanning unit for causing the infrared sensor to perform scanning, and
the scanning unit causes the infrared sensor to scan an area around the occupant at a scanning speed slower than a scanning speed at which the infrared sensor an area in which the occupant does not exist.

6. The air-conditioning control apparatus according to claim 5, wherein, after capturing an image of an area around a driver, the first detector captures an image of an area around an occupant other than the driver.

7. The air-conditioning control apparatus according to claim 5, wherein the first detector causes the infrared sensor to be fixed at a predetermined position, and captures an image of an area around the occupant upon detecting the occupant.

8. The air-conditioning control apparatus according to claim 5, wherein the first detector further includes:
a mirror for performing scanning according to a refresh rate of the infrared sensor;
an actuator that causes the mirror to perform scanning; and
an imaging lens provided between the infrared sensor and the mirror.

9. The air-conditioning control apparatus according to claim 8, wherein the actuator includes a piezoelectric body, and causes the mirror to perform scanning by a piezoelectric effect of the piezoelectric body.

10. The air-conditioning control apparatus according to claim 8, wherein the actuator causes the mirror to perform scanning by an electrostatic attracting force.

11. The air-conditioning control apparatus according to claim 8, wherein the actuator causes the mirror to perform scanning by a Lorentz force.

12. The air-conditioning control apparatus according to claim 8, wherein
the actuator includes:
a first beam having a first resonance frequency; and
a second beam having a second resonance frequency, and
the first resonance frequency is different from the second resonance frequency.

13. The air-conditioning control apparatus according to claim 8, wherein the mirror is a parabolic mirror.

14. The air-conditioning control apparatus according to claim 8, wherein the lens is formed unitarily with the mirror.

15. The air-conditioning control apparatus according to claim 8, wherein the mirror is made of a photonic crystal with a modulatable refractive index.

16. The air-conditioning control apparatus according to claim 8, wherein the mirror includes a motor.
